(19) United States
(12) Patent Application Publication
(10) Pub. No.: US 2020/0320657 A1
(43) Pub. Date: Oct. 8, 2020

(54) ITEM RETURN DEVICES AND ITEMS USING THE SAME

(71) Applicant: BEIJING QISHENG SCIENCE AND TECHNOLOGY CO., LTD., Beijing (CN)

(72) Inventor: Fei LU, Hangzhou (CN)

(73) Assignee: BEIJING QISHENG SCIENCE AND TECHNOLOGY CO., LTD., Beijing (CN)

(21) Appl. No.: 16/904,512

(22) Filed: Jun. 17, 2020

Related U.S. Application Data
(63) Continuation of application No. PCT/CN2018/095622, filed on Jul. 13, 2018.

(30) Foreign Application Priority Data
Dec. 17, 2017 (CN) 201721767914.6
Feb. 14, 2018 (CN) 201810152393.6

(51) Int. Cl. G06Q 50/30; G06Q 10/08; G06Q 30/00; G06Q 20/08; H04L 9/32; G06F 16/901; G06K 19/06; H04L 29/08

(52) U.S. Cl. CPC G06Q 50/30; G06Q 10/0837; G06Q 30/0185; G06Q 20/085; H04L 9/32; G06Q 30/0645; G06K 19/06037; H04L 67/141; H04L 67/10; G06Q 2220/00; G06Q 2240/00; G06F 16/9017

(57) ABSTRACT

A control device in communication with a server via a network is provided. The control device may include a return component mounted on an item and a transceiver mounted on the item. The return component may be configured to receive an operation of a user on the return component and generate a return request based on the operation of the user on the return component. The transceiver may be configured to establish a connection with the server, encrypt the return request and identification information of the item to generate encrypted data, and transmit the encrypted data to the server to register a return of the item on the server.

### CROSS-REFERENCE TO RELATED APPLICATIONS

This application is a continuation of International Application No. PCT/CN2018/095622, filed on Jul. 13, 2018, which claims priority to Chinese Patent Application No. 201721767914.6, filed on Dec. 17, 2017, and Chinese Patent Application No. 201810152393.6, filed on Feb. 14, 2018, the entire contents of each of which are hereby incorporated by reference.

### TECHNICAL FIELD

The present application relates to the field of item return devices and items using the same, and in particular, to item return devices in communication with an online-to-offline system and items using the same.

### BACKGROUND

Item sharing (e.g., vehicle sharing, book sharing, room sharing, computer sharing) has become increasingly popular in recent years.

Usually, a user borrows a shared item by scanning a quick response (QR) code on the item using his or her mobile device and register a borrow of the item on an application installed in the mobile device and an online-to-offline (O2O) system. When the user finishes using the item, the user may return the item (e.g., make the item available to the public again) by taking return actions such as scanning the QR code on the item again and/or selecting a return option on the application installed in the mobile device. However, the return actions are complex and time consuming. Also, the return actions need an internet access of the mobile device and take a long time if the user is at a location having a poor reception. Thus, it may be desired to provide item return devices and shared items using the item return devices for returning the shared items in a convenient way.

### SUMMARY

According to an aspect of the present disclosure, a control device in communication with a server via a network is provided. The control device may include a return component mounted on an item and a transceiver mounted on the item. The return component may be configured to receive an operation of a user on the return component and generate a return request based on the operation of the user on the return component. The transceiver may be configured to establish a connection with the server, encrypt the return request and identification information of the item to generate encrypted data, and transmit the encrypted data to the server to register a return of the item on the server.

In some embodiments, the transceiver may be further configured to receive a return completion signal from the server, and cause a lock mounted on the item to lock the item according to the return completion signal.

In some embodiments, the return component may include at least one of: a button, a knob, a microphone, a switch, or a touch screen.

In some embodiments, the operation on the return component may include at least one of: a touch, a gesture, a voice command, a press, a pull, a drag, a rotation, a movement, or a click.

According to another aspect of the present disclosure, a method for returning an item is provided. The method may be implemented on a computing device having at least one processor and at least one computer-readable storage medium. The method may include receiving, by a return component mounted on an item, an operation of a user on the return component and generating, by the return component mounted on the item, a return request based on the operation of the user on the return component. The method may further include establishing, by a transceiver mounted on the item, a connection with a server, encrypting, by the transceiver, the return request and identification information of the item to generate encrypted data, and transmitting, by the transceiver, the encrypted data to the server to register a return of the item on the server.

According to another aspect of the present disclosure, a non-transitory computer-readable storage medium is provided. The non-transitory computer-readable storage medium may store instructions that, when executed by at least one processor of a system, cause the system to perform a method, the method may include receiving, by a return component mounted on an item, an operation of a user on the return component and generating, by the return component mounted on the item, a return request based on the operation of the user on the return component. The method may further include establishing, by a transceiver mounted on the item, a connection with a server, encrypting, by the transceiver, the return request and identification information of the item to generate encrypted data, and transmitting, by the transceiver, the encrypted data to the server to register a return of the item on the server.

According to another aspect of the present disclosure, a server in communication with a control device on an item and a user device via a network may be provided. The server may be configured to receive, from the control device, first encrypted data including a return request of the item and identification information of the item and decrypt the first encrypted data to generate the return request of the item and the identification information of the item. The server may be further configured to determine an account associated with the identification information of the item and determine whether the item is checked out to the account to obtain a determination result. The server may be further configured to generate, based on the determination result, second data including information regarding the account, encrypt the second data, and push the second encrypted data to the user device associated with the account.

In some embodiments, to determine whether the item is checked out to the account to obtain a determination result may include determining that the item is not checked out to the account, and the second data may include a verification request associated with the account.

In some embodiments, to determine whether the item is checked out to the account to obtain a determination result may include determining that the item is checked out to the account, and the second data may include a status change of the account relating to the item from checkout to return.

In some embodiments, the server may be further directed to charge a fee on the account.

In some embodiments, the second data may further include a return completion signal associated with the account.

In some embodiments, to determine an account associated with the identification information, the server may be directed to obtain a lookup table recording mappings between identification information of a plurality of items and a plurality of accounts, wherein the lookup table is updated each time when one of the plurality of items is checked out or returned and search the lookup table based on the identification information of the item to identify the account to which the item is checked out.

In some embodiments, to determine whether the item is checked out to the account to obtain a determination result, the server may be further directed to determine that the item is checked out to the account and delete, from the lookup table, the mapping between the identification information of the item and the account to which the item is checked out.

According to another aspect of the present disclosure, a method for returning an item implemented on a computing device having one or more processors and one or more storage devices may be provided. The method may include receiving, from a control device, first encrypted data including a return request of the item and identification information of the item and decrypting the first encrypted data to generate the return request of the item and the identification information of the item. The method may include determining an account associated with the identification information of the item and determining whether the item is checked out to the account to obtain a determination result. The method may further include generating, based on the determination result, second data including information regarding the account, encrypting the second data, and pushing the second encrypted data to a user device associated with the account.

According to another aspect of the present disclosure, a server in communication with a control device on an item and a user device via a network may be provided. The server may include a receiving module configured to receive, from the control device, first encrypted data including a return request of the item and identification information of the item, a decryption module configured to decrypt the first encrypted data to generate the return request of the item and the identification information of the item, an account determination module configure to determine an account associated with the identification information of the item, a result determination module configured to determine whether the item is checked out to the account to obtain a determination result, a generation module configured to generate, based on the determination result, second data including information regarding the account, an encryption module configured to encrypt the second data, and a push module configured to push the second encrypted data to the user device associated with the account.

According to an aspect of the present disclosure, a non-transitory computer-readable storage medium may be provided. The non-transitory computer-readable storage medium may store instructions that, when executed by at least one processor of a system, cause the system to perform a method. The method may include receiving, from a control device, first encrypted data including a return request of the item and identification information of the item and decrypting the first encrypted data to generate the return request of the item and the identification information of the item. The method may include determining an account associated with the identification information of the item and determining whether the item is checked out to the account to obtain a determination result. The method may further include generating, based on the determination result, second data including information regarding the account, encrypting the second data, and pushing the second encrypted data to a user device associated with the account.

Additional features will be set forth in part in the description which follows, and in part will become apparent to those skilled in the art upon examination of the following and the accompanying drawings or may be learned by production or operation of the examples. The features of the present disclosure may be realized and attained by practice or use of various aspects of the methodologies, instrumentalities, and combinations set forth in the detailed examples discussed below.

### BRIEF DESCRIPTION OF THE DRAWINGS

The present disclosure is further described in terms of exemplary embodiments. These exemplary embodiments are described in detail with reference to the drawings. These embodiments are non-limiting exemplary embodiments, in which like reference numerals represent similar structures throughout the several views of the drawings, and wherein:

FIG. 1 is a schematic diagram illustrating an exemplary vehicle sharing system 100 according to some embodiments of the present disclosure;

FIG. 2 is a schematic diagram illustrating exemplary hardware and/or software components of a computing device 200 according to some embodiments of the present disclosure;

FIG. 3 is a schematic diagram illustrating exemplary hardware and/or software components of a mobile device 300 according to some embodiments of the present disclosure;

FIG. 4 is a block diagram illustrating an exemplary control device and an exemplary server according to some embodiments of the present disclosure;

FIG. 5 is a flowchart illustrating an exemplary process for returning an item according to some embodiments of the present disclosure;

FIG. 6 is a flowchart illustrating an exemplary process for registering the return of an item according to some embodiments of the present disclosure;

FIG. 7 is a flowchart illustrating an exemplary process for determining an account associated with identification information of an item according to some embodiments of the present disclosure;

FIG. 8 is a schematic diagram of an exemplary lookup table according to some embodiments of the present disclosure;

FIG. 9 is a schematic diagram of an exemplary operation panel according to some embodiments of the present disclosure;

FIG. 10 is a schematic diagram of exemplary items according to some embodiments of the present disclosure;

FIG. 11 is a schematic diagram illustrating an exemplary vehicle according to some embodiments of the present disclosure;

FIG. 12 is a schematic diagram illustrating an exemplary vehicle according to some embodiments of the present disclosure;

FIG. 13 is a schematic diagram illustrating an exemplary vehicle according to some embodiments of the present disclosure;

FIG. 14 is a schematic diagram illustrating an exemplary wheel of a vehicle according to some embodiments of the present disclosure; and

FIG. 15 is a schematic diagram illustrating an exemplary wheel of a vehicle according to some embodiments of the present disclosure;

### DETAILED DESCRIPTION

The following description is presented to enable any person skilled in the art to make and use the present disclosure and is provided in the context of a particular application and its requirements. Various modifications to the disclosed embodiments will be readily apparent to those skilled in the art, and the general principles defined herein may be applied to other embodiments and applications without departing from the spirit and scope of the present disclosure. Thus, the present disclosure is not limited to the embodiments shown, but is to be accorded the widest scope consistent with the claims.

The terminology used herein is to describe particular exemplary embodiments only and is not intended to be limiting. As used herein, the singular forms “a,” “an,” and “the” may be intended to include the plural forms as well, unless the context expressly indicates otherwise. It will be further understood that the terms “comprise,” “comprises,” and/or “comprising,” “include,” “includes,” and/or “including,” when used in the present disclosure, specify the presence of stated features, integers, steps, operation, elements, and/or components, but do not preclude the presence or addition of one or more other features, integers, steps, operation, elements, components, and/or groups thereof.

These and other features, and characteristics of the present disclosure, as well as the methods of operation and functions of the related elements of structure and the combination of parts and economies of manufacture, may become more apparent upon consideration of the following description with reference to the accompanying drawings, all of which form a part of the present disclosure. It is to be expressly understood, however, that the drawings are for illustration and description only, and are not intended to limit the scope of the present disclosure. It is understood that the drawings are not to scale.

It will be understood that the term “system,” “engine,” “unit,” and/or “module” used herein are one method to distinguish different components, elements, parts, sections, or assemblies of different levels in ascending order. However, the terms may be displaced by other expressions if they achieve the same purpose.

It will be understood that when a unit, engine, or module is referred to as being “on,” “connected to,” or “coupled to,” another unit, engine, or module, it may be directly on, connected or coupled to, or communicate with the other unit, engine, or module, or an intervening unit, engine, or module may be present, unless the context clearly indicates otherwise. As used herein, the term “and/or” includes any and all combinations of one or more of the associated listed items.

The flowcharts used in the present disclosure illustrate operation that systems implement according to some embodiments of the present disclosure. It is to be expressly understood, the operation of the flowcharts may be implemented not in order. Conversely, the operation may be implemented in inverted order, or simultaneously. Moreover, one or more other operations may be added to the flowcharts. One or more operations may be omitted from the flowcharts.

Moreover, while the systems and methods described in the present disclosure are described primarily regarding a vehicle sharing service, it should also be understood that they are merely exemplary embodiments. The systems or methods described in the present disclosure may apply to any other kind of economic sharing service that transfers a usufruct from one to another in an online rental transaction. For example, the systems or methods of the present disclosure may apply to physical asset renting and/or a service. The physical asset may include real estate (e.g., a hotel, a room, or an apartment), vehicles (e.g., a car, a bicycle, an electric bicycle, a bus, a hot-air balloon, or an airplane), goods (e.g., books, computers, tablet computers, clothes, an umbrella, a charger, or a microphone), etc. The service may include pet adoption, housekeeping, designated driving, etc. The application of the systems or methods of the present disclosure may include a web page, a plug-in for a browser, a client terminal, a custom system, an internal analysis system, an artificial intelligence robot, or the like, or any combination thereof.

The terms “cyclist,” “vehicle user,” “requestor,” “service requestor,” “driver,” “requestor terminal,” and “user” in the present disclosure are used interchangeably to refer to an individual, an entity, or a tool that may request or order a vehicle sharing service.

The positioning technology used in the present disclosure may be based on a global positioning system (GPS), a global navigation satellite system (GLONASS), a compass navigation system (COMPASS), a Galileo positioning system, a quasi-zenith satellite system (QZSS), a wireless fidelity (WiFi) positioning technology, or the like, or any combination thereof. One or more of the above positioning systems may be used interchangeably in the present disclosure.

It should be noted that the item sharing service (e.g., the vehicle sharing service) is a new form of service rooted only in post-Internet era. It provides technical solutions to users and service providers that could raise only in the post-Internet era. In the pre-Internet era, when a user needs to rent a vehicle in a vehicle rental shop, the rental request and acceptance occur only between the user and a shopkeeper of the vehicle rental shop who meet each other at a physical place. Through the Internet (and/or other types of network technology like Bluetooth), the vehicle sharing service, however, allows a user of the service to acquire a location of a vehicle accurately and rent a vehicle anywhere and anytime. It also allows the user to return the vehicle (e.g., return the item and make it available to public again) in any area where the parking of the vehicle is allowed. Therefore, through the Internet, a vehicle sharing system may provide a more convenient transaction platform for users and service providers that may never meet in the settings of the traditional, pre-Internet vehicle service.

The present disclosure relates to item return devices (or referred to as item control devices) and items using the item return devices. The item return device may include a return component (e.g., a button) mounted on a shared item. When a user finishes using the item, he or she may press the button. The return component may generate a return request in response to the press of the button. The item return devices may further include a transceiver mounted on the item to transmit the return request to a server together with identification information of the item. The communication between the transceiver and the server may be encrypted or unencrypted. The server may check a lookup table stored in a storage device of the server based on the identification information of the item to determine an account that borrows the item. The server may change the status of the account from checkout to return and send a return completion signal to the transceiver of the item return device. The item return device may control a lock to lock the item. The lock of the locked item may be opened when the item is borrowed again.

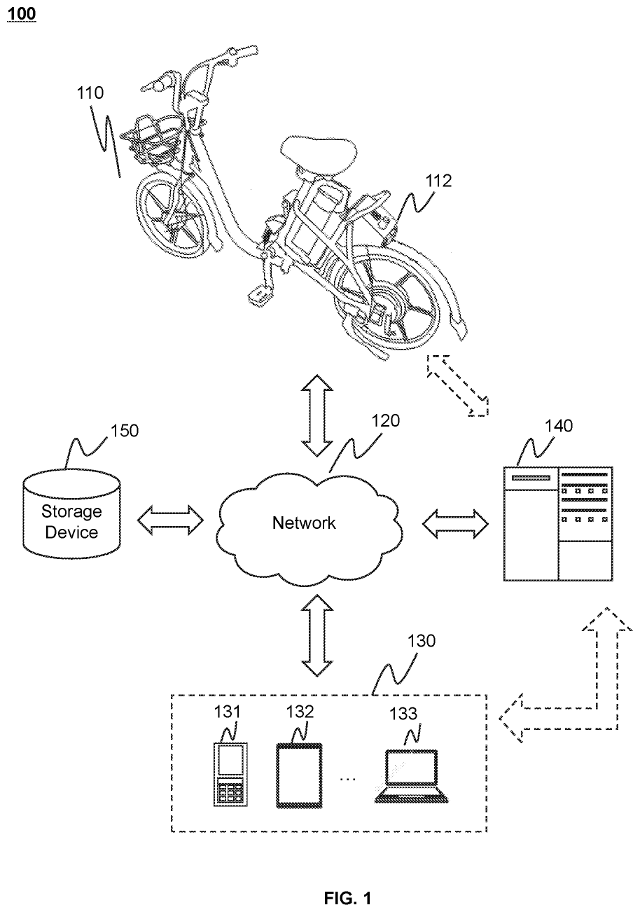

FIG. 1 is a schematic diagram illustrating an exemplary vehicle sharing system 100 according to some embodiments of the present disclosure. The vehicle sharing system 100 may include a vehicle 110, a network 120, a storage device 150, a server 140, and a user terminal 130 (or referred to as a user device). The vehicle sharing system 100 may further include a lock (not shown in the figure) that locks or unlocks the vehicle 110 based on an instruction generated by a control device 112 (also referred to as a control assembly, a vehicle control device, a vehicle return device, an item control device, an item return device, or a return device) mounted on the vehicle 110. In some embodiments, the vehicle 110 may be a bicycle, an electric bicycle, etc. Alternatively, the control device 112 may be installed on any kind of shared item used in an item sharing service, including but not limited to books, computers, tablet computers, clothes, umbrellas, battery chargers, etc. When the vehicle 110 is replaced by other kind of shared items, the vehicle sharing system 100 may be referred to as an item sharing system 100.

In some embodiments, the vehicle 110 may include a control device 112. The control device 112 may process information and/or data related to performing one or more functions in the present disclosure. For example, the control device 112 may transmit or receive information from or to the server 140. As another example, the control device 112 may generate instructions to control a lock to lock the vehicle 110. In some embodiments, the processing engine 112 may include one or more processing units (e.g., single-core processing engine(s) or multi-core processing engine(s)). Merely by way of example, the processing engine 112 may include a central processing unit (CPU), an application-specific integrated circuit (ASIC), an application-specific instruction-set processor (ASIP), a graphics processing unit (GPU), a physics processing unit (PPU), a digital signal processor (DSP), a field programmable gate array (FPGA), a programmable logic device (PLD), a controller, a microcontroller unit, a reduced instruction-set computer (RISC), a microprocessor, or the like, or any combination thereof.

The server 140 may communicate with the user terminal 130, the vehicle 110 (e.g., the control device 112), to provide various functionalities of the vehicle sharing service. For example, the server 140 may receive a service request (a checkout request) from the user terminal 130 via, for example, the network 120. The service request may include information relating the user (e.g., the user account information) and/or the user terminal 130 (e.g., the location of the user terminal 130). As another example, the server 140 may change the status of an account relating to a shared vehicle from checkout to return, or vice versa.

In some embodiments, the server 140 may be a single server or a server group. The server group may be a centralized server group connected to the network 120 via an access point or a distributed server group connected to the network 120 via one or more access points, respectively. In some embodiments, the server 140 may be locally connected to the network 120 or in remote connection with the network 120. For example, the server 140 may access information and/or data stored in the user terminal 130, the control device 112, and/or the storage device 150 via the network 120. As another example, the storage device 150 may serve as backend data storage of the server 140 or the control device 112. In some embodiments, the server 140 may be implemented on a cloud platform. Merely by way of example, the cloud platform may include a private cloud, a public cloud, a hybrid cloud, a community cloud, a distributed cloud, an inter-cloud, a multi-cloud, or the like, or any combination thereof.

The network 120 may facilitate exchange of information and/or data. In some embodiments, one or more components of the vehicle sharing system 100 (e.g., the server 140, the user terminal 130, the control device 112, the storage device 150) may transmit information and/or data to another component(s) in the vehicle sharing system 100 via the network 120. In some embodiments, the control device 112 may communicate directly with the server 140 without accessing the network 120.

In some embodiments, the network 120 may be any type of wired or wireless network, or combination thereof. Merely by way of example, the network 120 may include a cable network, a wireline network, an optical fiber network, a telecommunications network, an intranet, an Internet, a local area network (LAN), a wide area network (WAN), a wireless local area network (WLAN), a metropolitan area network (MAN), a wide area network (WAN), a public telephone switched network (PSTN), a Bluetooth network, a ZigBee network, a near field communication (NFC) network, or the like, or any combination thereof. In some embodiments, the network 120 may include one or more network access points.

In some embodiments, a user may be an owner of the user terminal 130. The user terminal 130 may receive input from the user and transmit the information relating to the input to the server 140 via the network 120. The user terminal 130 may also receive information from the control device 112 and/or the server 140 via the network 120. For example, the user terminal 130 may receive input from the user relating to a service request for a vehicle to the server 140, receive a service confirmation, and/or information or instructions from the server 140. The user terminal 130 may also receive a confirmation after the vehicle 110 is successfully checked out or returned.

In some embodiments, the user terminal 130 may include a mobile device 131, a tablet computer 132, a laptop computer 133, or the like, or any combination thereof. In some embodiments, the mobile device 131 may include a smart home device, a wearable device, a smart mobile device, a virtual reality device, an augmented reality device, or the like, or any combination thereof. In some embodiments, the smart home device may include a smart lighting device, a control device of an intelligent electrical apparatus, a smart monitoring device, a smart television, a smart video camera, an interphone, or the like, or any combination thereof. In some embodiments, the wearable device may include a smart bracelet, a smart footgear, smart glass, a smart helmet, a smart watch, smart clothing, a smart backpack, a smart accessory, or the like, or any combination thereof. In some embodiments, the smart mobile device may include a smartphone, a personal digital assistant (PDA), a gaming device, a navigation device, a point of sale (POS) device, or the like, or any combination thereof. In some embodiments, the virtual reality device and/or the augmented reality device may include a virtual reality helmet, a virtual reality glass, a virtual reality patch, an augmented reality helmet, an augmented reality glass, an augmented reality patch, or the like, or any combination thereof. For example, the virtual reality device and/or the augmented reality device may include a Google Glass™, an Oculus Rift™, a Hololens™, a Gear VR™, etc. In some embodiments, the user terminal 130 may include a signal transmitter and a signal receiver configured to communicate with a positioning device for locating the position of the user and/or the user terminal 130.

The storage device 150 may store data and/or instructions. The data may include data related to users, user terminals 130, vehicles 110, etc. For example, the vehicle 110 may be a bicycle. The data related to the users may include user profiles including for example, names of the users, mobile numbers of the users, ID numbers of the users, types of the users (e.g., annual card users, quarterly card users, or monthly card users), usage records of the users (e.g., riding time, riding miles, temporarily locked time), credit rating of the users, historical routes, account balance, etc. The data related to the vehicles 110 may include service conditions of the vehicles (e.g., an available status, a temporarily locked status, an end temporarily locked status, on a ride, in a maintenance status), positions of the vehicles, types of the vehicles (e.g., a unicycle, a bicycle, a tricycle, a tandem, a motor bicycle, an electric bicycle), etc. In some embodiments, the storage device 150 may store data obtained from the user terminal 130 and/or the vehicle 110. For example, the storage device 150 may store log information associated with the user terminal 130. In some embodiments, the storage device 150 may store data and/or instructions that the server 140 may execute or use to perform exemplary methods described in the present disclosure. For example, the storage device 150 may store a lookup table recording mappings between identification information of items and accounts.

In some embodiments, the storage device 150 may include a mass storage, removable storage, a volatile read-and-write memory, a read-only memory (ROM), or the like, or any combination thereof. Exemplary mass storage may include a magnetic disk, an optical disk, a solid-state drive, etc. Exemplary removable storage may include a flash drive, a floppy disk, an optical disk, a memory card, a zip disk, a magnetic tape, etc. Exemplary volatile read-and-write memory may include a random access memory (RAM). Exemplary RAM may include a dynamic RAM (DRAM), a double date rate synchronous dynamic RAM (DDR SDRAM), a static RAM (SRAM), a thyristor RAM (T-RAM), and a zero-capacitor RAM (Z-RAM), etc. Exemplary ROM may include a mask ROM (MROM), a programmable ROM (PROM), an erasable programmable ROM (EPROM), an electrically erasable programmable ROM (EEPROM), a compact disk ROM (CD-ROM), and a digital versatile disk ROM, etc. In some embodiments, the storage device 150 may be implemented on a cloud platform. Merely by way of example, the cloud platform may include a private cloud, a public cloud, a hybrid cloud, a community cloud, a distributed cloud, an inter-cloud, a multi-cloud, or the like, or any combination thereof.

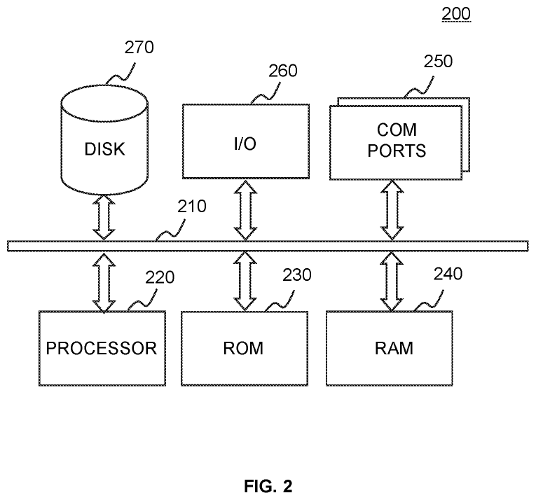

FIG. 2 is a schematic diagram illustrating exemplary hardware and/or software components of a computing device 200 according to some embodiments of the present disclosure. The computing device 200 may be a general purpose computer or a special purpose computer. The computing device 200 may be used to implement any component of the vehicle sharing system 100 as described herein. For example, the control device 112 of the vehicle 110, the server 140, and/or the user terminal 130 may be implemented on the computing device 200, via its hardware, software program, firmware, or a combination thereof. Although only one such computer is shown for convenience, the computer functions related to the vehicle sharing service as described herein may be implemented in a distributed manner on a number of similar platforms to distribute the processing load.

The computing device 200, for example, may include COM ports 250 connected to and from a network (e.g., the network 120) connected thereto to facilitate data communications. The computing device 200 may also include a processor 220 for executing program instructions to perform the functions of the control device 112, the server 140, and/or the user terminal 130 described herein. The computing device 200 may include an internal communication bus 210, program storage and data storage of different forms, for example, a disk 270, and a read only memory (ROM) 230, or a random access memory (RAM) 240, for various data files to be processed and/or transmitted by the computing device 200. The computing device 200 may also include program instructions stored in the ROM 230, the RAM 240, and/or another type of non-transitory storage medium to be executed by the processor 220. The methods and/or processes of the present disclosure may be implemented as the program instructions. The computing device 200 may also include an I/O 260, supporting input/output between the computing device 200, the user, and other components in the vehicle sharing system 100. The computing device 200 may also receive programming and data via network communications.

Merely for illustration, only one CPU and/or processor is described in the computing device 200. However, it should be noted that the computing device 200 in the present disclosure may also include multiple CPUs and/or processors, thus operation and/or method steps that are performed by one CPU and/or processor as described in the present disclosure may also be jointly or separately performed by the multiple CPUs and/or processors. For example, the CPU and/or processor of the computing device 200 may execute both step A and step B. As in another example, step A and step B may also be performed by two different CPUs and/or processors jointly or separately in the computing device 200 (e.g., the first processor executes step A and the second processor executes step B, or the first and second processors jointly execute steps A and B).

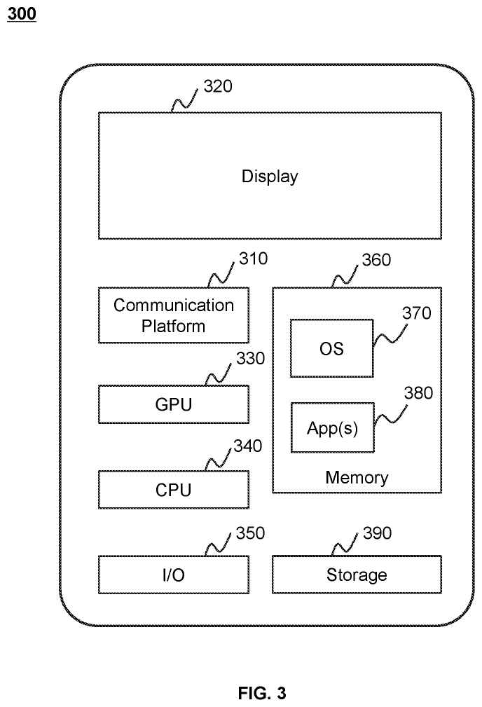

FIG. 3 is a schematic diagram illustrating exemplary hardware and/or software components of a mobile device 300 according to some embodiments of the present disclosure. As illustrated in FIG. 3, the mobile device 300 may include a communication platform 310, a display 320, a graphic processing unit (GPU) 330, a processor (or CPU) 340, an I/O 350, a memory 360, and a storage 390. In some embodiments, any other suitable component, including but not limited to a system bus or a controller (not shown in the figure), may also be included in the mobile device 300. In some embodiments, a mobile operating system 370 (e.g., iOS™, Android™, Windows Phone™) and one or more applications 380 may be loaded into the memory 360 from the storage 390 in order to be executed by the CPU 340. The applications 380 may include a browser or any other suitable apps for transmitting, receiving and presenting information relating to the status of the vehicle 110 (e.g., a checkout status, a return status, a temporary return status) from the server 140. User interactions with the information stream may be achieved via the I/O 350 and provided to the server 140 and/or other components of the vehicle sharing system 100 via the network 120. In some embodiments, the server 140 may transmit a verification signal to the mobile device 300 (or the application 380 thereof). The display 320 of the mobile device 300 may display the verification signal to the user to be further verified.

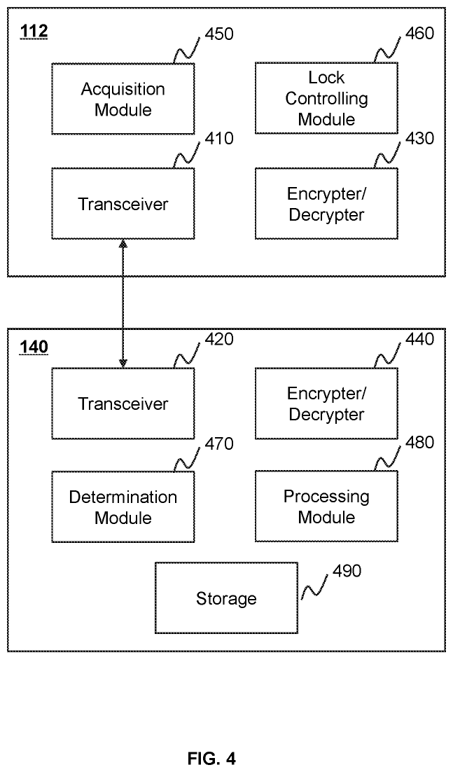

FIG. 4 is a block diagram illustrating an exemplary control device and an exemplary server according to some embodiments of the present disclosure. The control device 112 may include acquisition module 450, a lock controlling module 460, a transceiver 410, and an encrypter/decrypter 430. The server 140 may include a transceiver 420, an encrypter/decrypter 440, a determination module 470, a processing module 480, and a storage 490. Each of the modules described above may be a hardware circuit that is designed to perform certain actions, e.g. according to a set of instructions stored in one or more storage media, and/or any combination of the hardware circuit and the one or more storage media.

The acquisition module 450 of the control device 112 may acquire data/signals. In some embodiments, the acquisition module 450 may acquire identification information of the item. The identification information of the item may include a type of the item, a serial number of the item, a brand of the item, or the like, or any combination thereof. For example, the identification information may be “bike 2227.” As another example, the identification information may be “tablet computer 2231.” The identification information of the item may be stored in a storage device inside or outside of the control device 112.

The lock controlling module 460 of the control device 112 may control locking/unlocking of the item. For example, the lock controlling module 460 may send instructions to a lock mounted on the item to lock or unlock the item.

The encrypter/decrypter 430 of the control device 112 and the encrypter/decrypter 440 of the server 140 may encrypt/decrypt data/signals. In some embodiments, the encrypter/decrypter 430 may encrypt a return request received by a return component mounted on the item and the identification information of the item to generate an encrypted signal (or encrypted data). The return request and the identification information of the item may be encrypted by one or more encryption techniques. Exemplary encryption technique may include but not limited to Message Digest 5 (MD5), Secure Hashing Algorithm (SHA), Data Encryption Standard (DES), Advanced Encryption Standard (AES), International Data Encryption Algorithm (IDEA), RSA, Diffie-Hellman, or the like, or any combination thereof. In some embodiments, the return request and the identification information of the item may be encrypted serially (primarily as a long string) or parallelly (primarily as two short strings). When the return request and the identification information of the item are parallelly encrypted, the encryption technique of the return request and the encryption technique of the identification information may be the same or different.

In some embodiments, the encrypter/decrypter 440 of the server 140 may decrypt the encrypted signal including a return request and identification information of an item. The encrypted signal may be transmitted by the transceiver 410 of the control device 112. In some embodiments, the decryption technique may correspond to the encryption technique as described in the encrypter/decrypter 430. For example, if the signal is encrypted using an MD5 by the encrypter/decrypter 430, the signal may be decrypted by the encrypter/decrypter 440 using the MD5.

The transceiver 410 of the control device 112 and the transceiver 420 may transmit and/or receive data/signals. The transceiver 410 may transmit the encrypted signal to the transceiver 420 to register a return of the item on the server 140. In some embodiments, the transceiver 410 may establish a connection with the transceiver 420 before transmitting the encrypted signal to the server. For example, the transceiver 410 may transmit a connection request to the transceiver 420 and establish a connection with the transceiver 420 when the connection request is accepted by the transceiver 420. As another example, the transceiver 420 may transmit a connection request to the transceiver 410 and establish a connection with the transceiver 410 when the connection request is accepted by the transceiver 410.

The determination module 470 of the server 140 may determine an account associated with the identification information of the item. For example, when a user borrows an item, the account of the user may be mapped (or correlated) with the identification information of the item. The mappings between the account of the user and the identification information of the item may be stored in a lookup table (or any other forms that may record the mappings). The determination module 470 may determine the account by searching the lookup table based on the identification information of the item.

The processing module 480 of the server 140 may process data/signals. The processing module 420 may obtain the data/signals from the storage 490 and/or any storage devices capable of storing data/signals (e.g., the storage device 150, or an external data source). The processing module 480 may change the status of the account from checkout to return relating to the item. A checkout status may refer to a status that the item has checked out to the account and not been returned yet. A return status may refer to a status that the item has been returned under the account to which the item was checked out (and ready to borrow again). In some embodiments, the mappings on the lookup table may be updated corresponding to the status change of the account.

The processing module 480 may also charge a fee on the account. In some embodiments, the processing module 480 may charge a fee on the account after the user acknowledges the receipt of the information of status change of the account from checkout to return relating to the item. In some embodiments, the user may link one or more online payment options (e.g., debit card, credit card, PayPal, Alipay, Apple Pay) with the account. The processing module 480 may send the bill of the item sharing service to the account and the user may select one of the online payment options to pay for the bill. Alternatively, after getting the permission from the user, the processing module 480 may automatically charge the balance of the account or the accounts associated with the one or more linked online payment options.

The processing module 480 may include a hardware processor, such as a microcontroller, a microprocessor, a reduced instruction set computer (RISC), an application specific integrated circuits (ASICs), an application-specific instruction-set processor (ASIP), a central processing unit (CPU), a graphics processing unit (GPU), a physics processing unit (PPU), a microcontroller unit, a digital signal processor (DSP), a field programmable gate array (FPGA), an advanced RISC machine (ARM), a programmable logic device (PLD), any circuit or processor capable of executing one or more functions, or the like, or any combinations thereof.

The storage 490 of the server 140 may store data or information relating to the server 140, the vehicle 110, and/or the control device 112. In some embodiments, the storage 490 may store a lookup table. For example, when an item is checked out to an account by a user, the account of the user may be mapped (or correlated) with the identification information of the item and the mapping between the account of the user and the identification information of the item may be stored in the lookup table (or any other forms that record the mappings). The lookup table may be searched based on the identification information of the item to determine the account to which the item is checked out. In some embodiments, the storage 490 may be a machine including the lookup table. The storage 490 may include an input protocol and an output protocol. When the identification information of the item is input according to the input protocol, the storage 490 may search the lookup table and output relevant information to the account according to the output protocol.

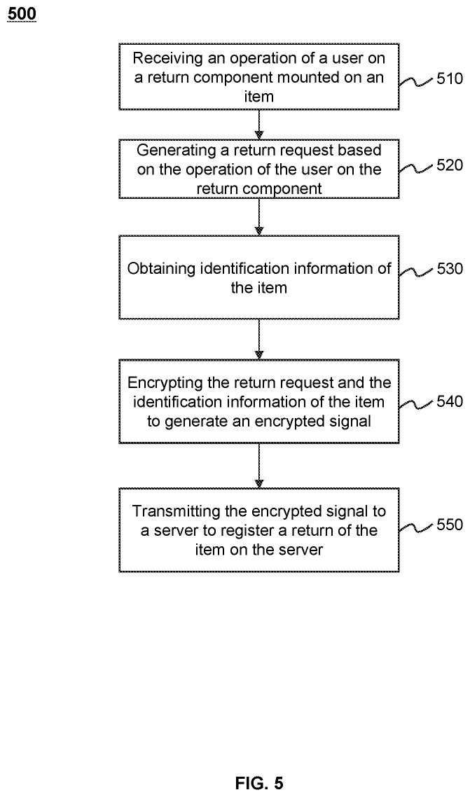

FIG. 5 is a flowchart illustrating an exemplary process for returning an item according to some embodiments of the present disclosure. In some embodiments, the process 500 may be implemented as a set of instructions (e.g., an application) stored in the ROM 230, RAM 240, or storage 390. The CPU 340, processor 220 and/or the modules in FIG. 4 may execute the set of instructions, and when executing the instructions, the CPU 340, the processor 220 and/or the modules in FIG. 4 may be configured to perform the process 500. The operations of the illustrated process present below are intended to be illustrative. In some embodiments, the process 500 may be accomplished with one or more additional operations not described and/or without one or more of the operations herein discussed. Additionally, the order in which the operations of the process as illustrated in FIG. 5 and described below is not intended to be limiting.

In 510, a return component mounted on an item may receive an operation of a user on the return component. The item may include but not limited to a vehicle (e.g., the vehicle 110), a book (e.g., the book 1000), a computer, a tablet computer (e.g., the tablet computer 1050), clothing, an umbrella, a battery charger, etc. The return component may include but not limited to a button, a knob, a microphone, a switch, or a touch screen mounted on the item. The operation may include but not limited to a touch, a gesture, a voice command, a press, a pull, a drag, a rotation, a movement, or a click. For example, a return button mounted on a vehicle (e.g., the vehicle 110) may receive a press of a vehicle user. As another example, a display of a tablet computer (e.g., the tablet computer 1050) may receive a click by a user on a “return” icon displayed on the display. The operation on the return component may be performed by the user to return the item.

In 520, the return component may generate a return request based on the operation of the user on the return component. In some embodiments, the return request may include the information that the user desires to return the item. The return request may further include the location and/or the time that the operation of the user is received. In some embodiments, the return request may be generated by electric circuits mounted on the return component. For example, a switching circuit mounted on the return component may be switched on to generate the return request when the return component is pressed.

In 530, the control device 112 (e.g., the acquisition module 450) may obtain identification information of the item. The identification information of the item may include a type of the item, a serial number of the item, a brand of the item, or the like, or any combination thereof. For example, the identification information may be “bike 2227.” As another example, the identification information may be “tablet computer 2231.” The identification information of the item may be stored in a storage device inside or outside of the control device 112.

In 540, the control device 112 (e.g., the encrypter/decrypter 430) may encrypt the return request and the identification information of the item to generate an encrypted signal. The return request and the identification information of the item may be encrypted by one or more encryption techniques. Exemplary encryption technique may include but not limited to Message Digest 5 (MD5), Secure Hashing Algorithm (SHA), Data Encryption Standard (DES), Advanced Encryption Standard (AES), International Data Encryption Algorithm (IDEA), RSA, Diffie-Hellman, or the like, or any combination thereof. In some embodiments, the return request and the identification information of the item may be encrypted serially (primarily as a long string) or parallelly (primarily as two short strings). When the return request and the identification information of the item are parallelly encrypted, the encryption technique of the return request and the encryption technique of the identification information may be the same or different.

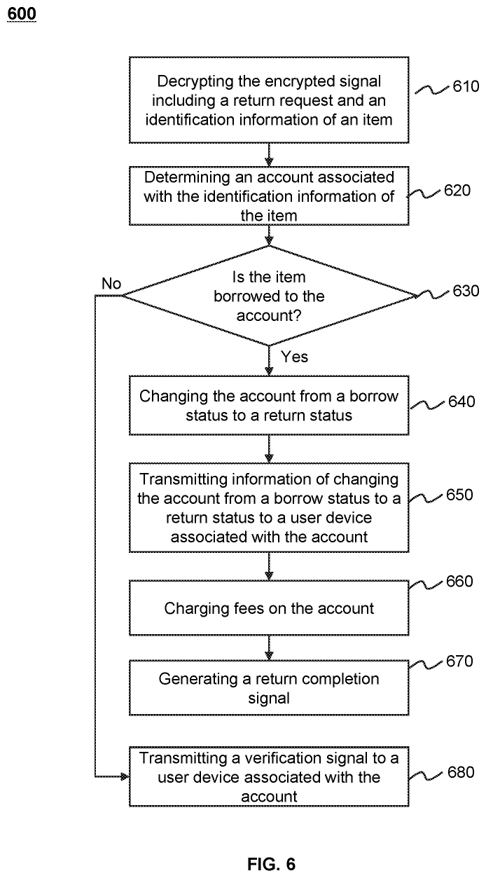

In 550, the control device 112 (e.g., transceiver 410) may transmit the encrypted signal to the server 140 to register a return of the item on the server 140. In some embodiments, the control device 112 may establish a connection with the server 140 before transmitting the encrypted signal to the server. For example, the control device 112 may transmit a connection request to the server and establish a connection with the server 140 when the connection request is accepted by the server 140. In some embodiments, the registration of the return of the item on the server 140 may include changing the status of the account to which the item is checked out from checkout to return relating to the item. More descriptions regarding the registration of the return of the item on the server 140 and subsequent operations of the server 140 after the registration of the return of the item may be found elsewhere in the present disclosure. See, e.g., process 600 in FIG. 6 and the descriptions thereof.

FIG. 6 is a flowchart illustrating an exemplary process for registering a return of the item according to some embodiments of the present disclosure. In some embodiments, the process 600 may be implemented as a set of instructions (e.g., an application) stored in the storage 390, ROM 230 or RAM 240. The CPU 340, processor 220 and/or the modules in FIG. 4 may execute the set of instructions, and when executing the instructions, the CPU 340, the processor 220 and/or the modules in FIG. 4 may be configured to perform the process 600. The operations of the illustrated process present below are intended to be illustrative. In some embodiments, the process 600 may be accomplished with one or more additional operations not described and/or without one or more of the operations herein discussed. Additionally, the order in which the operations of the process as illustrated in FIG. 6 and described below is not intended to be limiting. In some embodiments, process 600 may be performed by a server (e.g., the server 140) after a control device (e.g., control device 112) transmits an encrypted signal to the server as described in operation 550.

In 610, the server 140 (e.g., the encrypter/decrypter 440) may decrypt the encrypted signal (or encrypted data) including a return request and identification information of an item. The encrypted signal may be transmitted by the control device 112 in operation 550. In some embodiments, the decryption technique may correspond to the encryption technique as described in operation 540. For example, if the signal is encrypted using an MD5 by the encrypter/decrypter 430, the signal may be decrypted by the encrypter/decrypter 440 using the MD5.

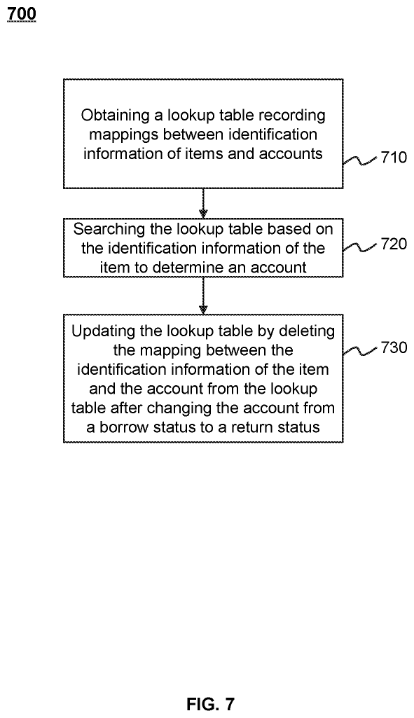

In 620, the server 140 (e.g., the determination module 470) may determine an account associated with the identification information of the item. For example, when a user borrows an item, the account of the user may be mapped (or correlated) with the identification information of the item. The mappings between the account of the user and the identification information of the item may be stored in a lookup table (or any other forms that may record the mappings). The server 140 may determine the account by searching the lookup table based on the identification information of the item. More descriptions regarding the determination of the account associated with the identification information of the item may be found elsewhere in the present disclosure. See, e.g., FIG. 7 and the descriptions thereof.

In 630, the server 140 (e.g., the determination module 470) may determine whether the item is checked out (or borrowed) to the account. Usually, the item is checked out to the account associated with the user and the item is returned by the user that borrows the item. However, it may be possible that users swaps their borrowed items during use. For example, a user A and a user B may each borrow a bike and may swap their bikes during use because of, e.g., the size, the color, the height of the bikes. When the user A or the user B returns the bike borrowed by the other, the server 140 may determine that the bike is not checked out to the account associated with the bike because of e.g., the location and/or the time that the bike is returned. As another example, it may be possible that a mistake exists in the mappings between the account and the identification information of the item. For example, a user A may borrow an item C; however, the server 140 may mistakenly map identification information of an item D with the user A. When the user A operates the return device on the item C to return the item C, the server 140 may determine an account associated with a user B based on the identification information of the item D. The server 140 may determine that the item C is not checked out to the account associated with the user B because of the time or location the user A returns the item C. In response to a determination that the item is checked out to the account determined in 620, the process 600 may proceed to 640; otherwise, the process 600 may proceed to 680.

In 640, the server 140 (e.g., the processing module 480) may change the status of the account from checkout to return relating to the item. A checkout status may refer to a status that the item has checked out to the account and not been returned yet. A return status may refer to a status that the item has been returned under the account to which the item was checked out (and ready to borrow again). In some embodiments, the mappings on the lookup table may be updated corresponding to the status change of the account.

In 650, the server 140 (e.g., the transceiver 420) may transmit information of status changing of the account relating to the item to a user device (e.g., the user terminal 130, the mobile device 300) associated with the account via e.g., a text message, a message in the item sharing service application. The information of status change of the account relating to the item may be displayed on a graphic user interface (GUI) of a display of the user device. In some embodiments, the user may acknowledge or confirm receipt of the information of status change of the account relating to the item by, e.g., clicking an icon (e.g., a ““yes” icon, a “confirmed” icon, etc.) set on the text message or displayed on the GUI of the item sharing service application.

In 660, the server 140 (e.g., processing module 480) may charge a fee on the account. In some embodiments, the server 140 may charge a fee on the account after the user acknowledges the receipt of the information of status change of the account from checkout to return relating to the item. In some embodiments, the user may link one or more online payment options (e.g., debit card, credit card, PayPal, Alipay, Apple Pay) with the account. The server 140 may send the bill of the item sharing service to the account and the user may select one of the online payment options to pay for the bill. Alternatively, after getting the permission from the user, the server 140 may automatically charge the balance of the account or the accounts associated with the one or more linked online payment options.

In 670, the server 140 (e.g., processing module 480) may generate a return completion signal. The service 140 may transmit the return completion signal (or an encrypted signal encoding the return completion signal) to the control device 112 of the vehicle 110. The control device 112 may, upon receipt of the return completion signal, control a lock mounted on the vehicle 110 to lock the vehicle 110. The locked vehicle 110 may be unlocked when it is borrowed again.

In 680, the server 140 (e.g., the transceiver 420) may transmit a verification request to a user device (e.g., the user terminal 130, the mobile device 300) associated with the account. The verification request may be displayed on a graphic user interface (GUI) of a display of the user device. The user may determine whether the item is actually borrowed and returned by him/her and respond to the verification request by, e.g., clicking one or more icons on the GUI set by the item sharing service application. As described in 630, the process 600 may proceed to 680 when a user A and a user B each borrow an item and swap their borrowed items with each other. In this case, if both the user A and the user B verify that the items are checked out (or borrowed) to their accounts correctly, the server 140 may proceed to 640. In some embodiments, the item is not checked out to the account at all (e.g., caused by a mistake) and the user may disaffirm the return of the item or otherwise notify the item sharing service application or the server 140 accordingly. In this case, the server 140 may find another account based on the time and location when the item is returned and transmit the verification request to the user device associated with the another account. If the server 140 cannot determine any account associated with the identification information of the item, the server 140 may cause the control device 112 on the item not to lock the item, and/or request the user who is attempting to return the item to, e.g., scan a QR code on the item or operate on his or her user device to manually input information of his or her account.

FIG. 7 is a flowchart illustrating an exemplary process for determining an account associated with identification information of an item according to some embodiments of the present disclosure. In some embodiments, the process 700 may be implemented as a set of instructions (e.g., an application) stored in the storage 390, ROM 230 or RAM 240. The CPU 340, processor 220 and/or the modules in FIG. 4 may execute the set of instructions, and when executing the instructions, the CPU 340, the processor 220 and/or the modules in FIG. 4 may be configured to perform the process 700. The operations of the illustrated process present below are intended to be illustrative. In some embodiments, the process 700 may be accomplished with one or more additional operations not described and/or without one or more of the operations herein discussed. Additionally, the order in which the operations of the process as illustrated in FIG. 7 and described below is not intended to be limiting. In some embodiments, process 700 may be performed to achieve operation 620.

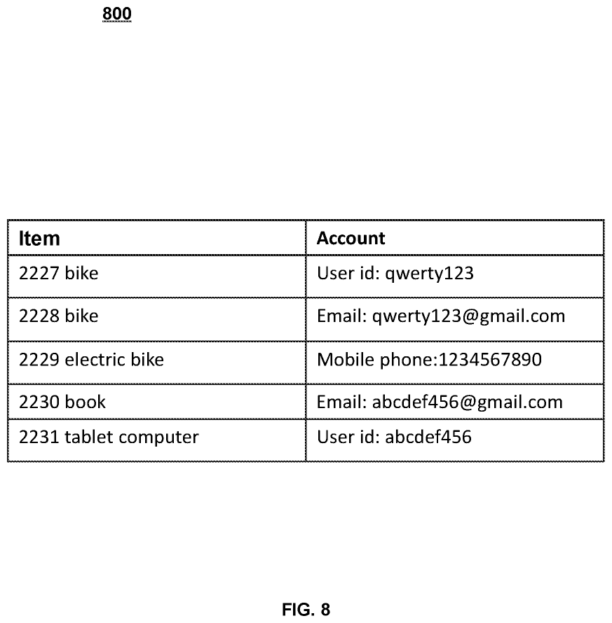

In 710, the server 140 may obtain a lookup table recording mappings between identification information of items and accounts. For example, when an item is checked out to an account by a user, the account of the user may be mapped (or correlated) with the identification information of the item and the mapping between the account of the user and the identification information of the item may be stored in the lookup table (or any other forms that record the mappings). The lookup table may be stored in a storage device (e.g., the storage device 150, the disk 270, storage 490). An exemplary lookup table may be found in, e.g., FIG. 8.

In 720, the server 140 may search the lookup table based on the identification information of the item to determine the account to which the item is checked out. In some embodiments, the lookup table may be embedded in a machine that includes an input protocol and an output protocol. When the identification information of the item is input according to the input protocol, the machine may search the lookup table and output relevant information to the account according to the output protocol.

In 730, the server 140 may update the lookup table by deleting the mapping between the identification information of the item and the account from the lookup table in response to the status change of the account from checkout to return relating to the item. Alternatively, the mapping between the identification information of the item and the account may not be directly deleted in response to the status change of the account. For example, the lookup table may include a checkout table and a return table. The checkout table may record mappings between identification information of items and accounts for accounts in a checkout status and the return table may record mappings between identification information of items and accounts for accounts in return status. In 730, the server 140 may move the mapping between the identification information of the item and the account from the checkout table to the return table. The return table may be deleted periodically to reduce the computation or storage demand of the server 140.

FIG. 8 is a schematic diagram of an exemplary lookup table according to some embodiments of the present disclosure. As shown in FIG. 8, the lookup table 800 may include mappings between items and accounts (e.g., each row of the lookup table 800 may correspond to a mapping between identification information of an item and an account). The identification information of the item may include the categories of the items (e.g., bike, electric bike, book, tablet computer), serial numbers of the items (e.g., 2227, 2228, 2229, 2230, 2231), brands of the items, or the like, or a combination thereof. The account may include information associated with the vehicle sharing system 100 including at least one of a user name, a user identity (ID), a real name, an email address, a phone number, or an account associated with an online payment option.

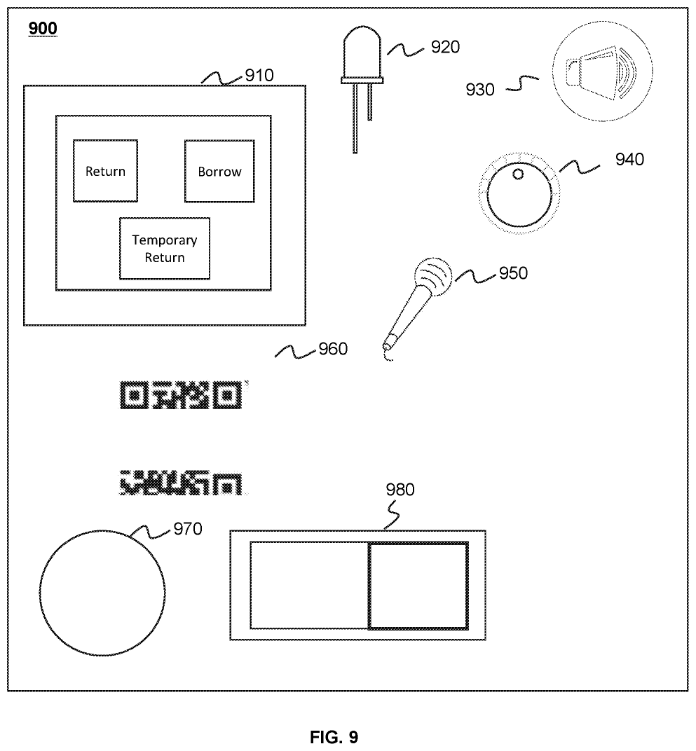

FIG. 9 is a schematic diagram of an exemplary control device according to some embodiments of the present disclosure. As shown in FIG. 9, the control device 900 may include a touch screen 910, a light emitter 920, a sound generator 930, a knob 940, a microphone 950, a QR code 960, a button 970, and a switch 980. Return components as described elsewhere in the present disclosure may include one or more of the touch screen 910, the knob 940, the microphone 950, the button 970, and/or the switch 980. The return components may receive an operation from a user when the user desires to return the item. For example, the touch screen 910 may receive a click or touch on an icon displayed thereon. As another example, the microphone 950 may receive a voice command. The user may scan the QR code 960 on the control device 900 when borrowing the item and operate the return components when returning the item. However, the user may also scan the QR code 960 when returning the item if the return components are not working properly or the server 140 cannot identify the account of the user associated with the item as described elsewhere in the present disclosure. In some embodiments, when the vehicle is returned, the light emitter 920 may emit a continuous light or blink to notify the user of the return. Similarly, the sound generator 930 may generate a sound to notify the user when the item is returned. It should be noted that although FIG. 9 illustrates the control device 900 as a control panel, the control device 900 may exist in other forms. In some embodiments, some of the components in the control device 900 may be omitted, other components may be added in the control device 900. Some of the components may be integrated with each other to realize similar functions of the components. In some embodiments, some of the components may reside in the control device 900 while some of the components may locate outside the control device 900.

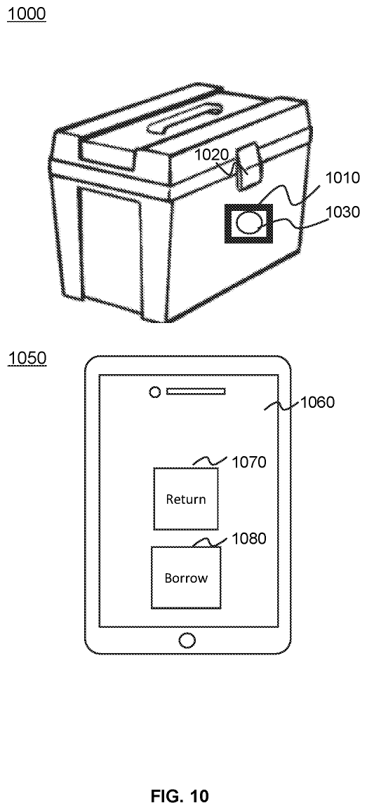

FIG. 10 is a schematic diagram of exemplary items according to some embodiments of the present disclosure. As shown in FIG. 10, a shared tool box 1000 may include a control device 1010 and a lock 1020. The control device 1010 may include a return component 1030 (e.g., a button). When the user desires to return the tool box, he or she may press the button 1030 and the control device 1010 may transmit a signal encoding the identification information of the tool box 1000 and the return request to a server (e.g., the server 140) to register a return of the tool box 1000. The server may transmit a return completion signal to the control device 1010 and the control device 1010 may control the lock 1020 to lock the tool box. In some embodiments, the lock 1020 may lock before the signal encoding the identification information of the tool box 1000 and the return request is transmitted to the server.

The tablet computer 1050 may include a touch screen 1060. A control device (not shown in the figure) in the tablet computer 1050 may control the touch screen 1060 to display a return icon 1070 and a checkout icon 1080. When the user clicks on the checkout icon 1080, the control device may cause the touch screen 1060 to display a login website to receive an account or identification information of a user for registering a checkout of the tablet computer 1050. When the user clicks on the return icon 1070, the control device may transmit a signal encoding the identification information of the tablet computer 1050 and the return request to a server (e.g., the server 140) to register a return of the tablet computer 1050. The server may transmit a return completion signal to the control device and the control device may lock the tablet computer 1050. When the tablet computer 1050 is locked, it may not be used until it is checked out again or an administrative password is entered.

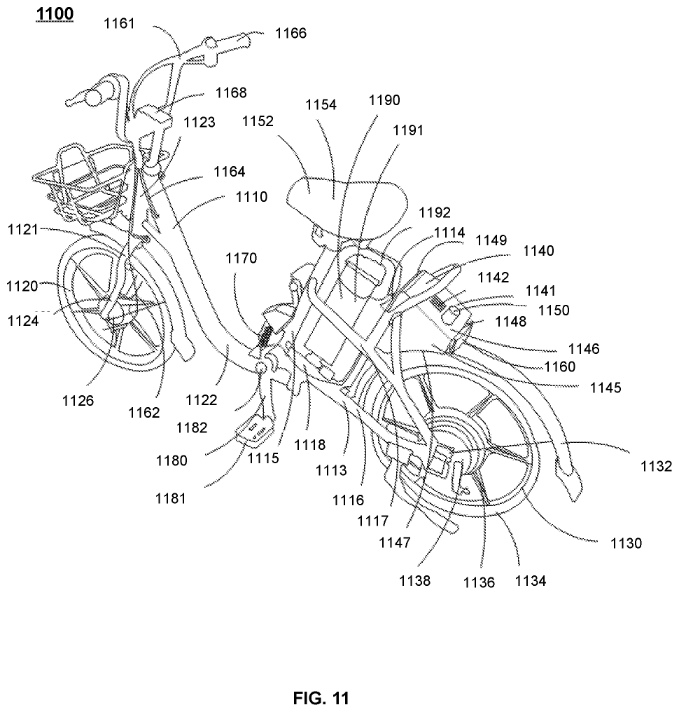

FIGS. 11-13 are schematic diagrams of an exemplary shared electric vehicle according to some embodiments of the present disclosure. As shown in FIGS. 11-13, the electric vehicle 1100 of the present disclosure may include a body 1110, and a front wheel assembly 1120 and a rear wheel assembly 1130 connected to the body 1110. The body 1110 may include a front frame 1121 that matches the front wheel assembly 1120 and a rear frame 1113 that matches the rear wheel assembly 1130.

The electric vehicle 1100 may further include a control assembly 1140 (also referred to as a control device 1140) and a vehicle control button 1150 (also referred to as a return component), wherein the vehicle control button 1150 is electrically connected to the control assembly 1140.

In some embodiments, the control assembly 1140 may include an interface (not shown in the figure). The interface may be connected to the electric vehicle 1100. For example, the interface may be connected to a motor (not shown in the figure) of the electric vehicle 1100, and the control assembly 1140 may control the operating state of the motor, and thus, control the state of the electric vehicle 1100. As another example, the interface may be connected to a lock (not shown in the figure) of the electric vehicle 1100, and the control assembly 1140 may control the opening or locking state of the lock.

In some embodiments, the control assembly 1140 and the vehicle control button 1150 may be arranged on a non-electric bicycle. The interface may be connected to a lock of the non-electric bicycle, and the control assembly 1140 may control the opening or locking state of the lock of the non-electric bicycle.

A user may perform a press operation on the vehicle control button 1150 to control the state of the vehicle. In some embodiments, by pressing the vehicle control button 1150, the user may achieve borrowing, return, temporary locking of the vehicle, or the like, or any combination thereof. In some embodiments, the vehicle control button 1150 may be a vehicle return button, and the user may achieve the vehicle return by pressing such button.

In some embodiments, the vehicle control assembly 1140 may control the vehicle to be in a first predetermined status when the vehicle control button 1150 receives a first press operation; and the vehicle control assembly 1140 may control the vehicle to be in a second predetermined status when the vehicle control button 1150 receives a second press operation. For example, the user may achieve the temporary vehicle locking by pressing the vehicle control button 1150 shortly or once, and achieve the vehicle return by long pressing the vehicle control button or pressing such button for twice within a time period (e.g., within 5 seconds, 10 seconds, etc.). As another example, the user may check out the vehicle by pressing the vehicle control button 1150 shortly or once, and achieve the vehicle return by long pressing the vehicle control button or pressing such button for twice within a time period (e.g., within 5 seconds, 10 seconds, etc.).

In some embodiments, the vehicle control button 1150 may be equipped with a cover (not shown in the figure). With the equipped cover, the button may be prevented from being touched by mistake, and meanwhile, the pollution or damage of the button may be reduced, thereby prolonging the life of the button.

In some embodiments, the control assembly 1140 may generate a signal of a vehicle status changing request when the vehicle control button 1150 is pressed, and transmit the signal of the vehicle status changing request to a server so that the vehicle is set to a predetermined status. For example, the user may achieve the borrowing, return or temporary locking of the vehicle by pressing the vehicle control button 1150. When the user presses the vehicle control button 1150, the control assembly 1140 may send a request to checkout, return, or temporarily lock the vehicle to the server. The server 140 may send a feedback signal of allowing the borrowing, return or temporary locking of the vehicle to the control assembly 1140 after receiving the request signal. The control assembly 1140 may control the vehicle to complete the borrowing, return or temporary locking of the vehicle after receiving the feedback signal sent by the server 140. The control assembly 1140 may also send a confirmation signal to the server 140 to confirm that the vehicle status has been changed after successfully completing the checkout, return, or temporary locking of the vehicle.

In some embodiments, a fingerprint collection circuit (not shown in the figure) may be set on the vehicle control button 1150 and operably connected to the control assembly 1140 such that the fingerprint collection circuit and the control assembly 1140 may exchange information or signals. Fingerprint information collected by the fingerprint collection circuit may be used for verifying the identity of the user. For example, the fingerprint collection circuit may collect the fingerprint information of the user and send the fingerprint information to the control assembly 1140, and the control assembly 1140 may verify the fingerprint information. In some embodiments, the control assembly 1140 may be equipped with a fingerprint verification circuit that may verify the fingerprint information. In other embodiments, the control assembly 1140 may include a processor and a computer program instruction, wherein the processor performs the computer program instruction to perform the fingerprint verification. As another example, the fingerprint collection circuit may collect the fingerprint information of the user, and send the fingerprint information to the control assembly 1140; the control assembly 1140 may send the fingerprint information to the server; and the server may verify the fingerprint information. The control assembly 1140 or the server may judge whether the operator has an operation authorization by verifying the fingerprint information. If the operator is deemed to have the privilege to operate the electric vehicle 1100, the control assembly 1140 or the server may perform a corresponding operation to grant access to the electric vehicle 1100; if the operator is deemed to lack the privilege to operate the electric vehicle 1100, the control assembly 1140 or the server may refuse the corresponding operation. In some embodiments, the control assembly 1140 or the server may compare the fingerprint information, collected by the fingerprint collection circuit, with fingerprint information of an authorized user. If the fingerprint information collected by the fingerprint collection circuit matches fingerprint information of an authorized user, the collected fingerprint information may be verified successfully, and the control assembly 1140 or the server may perform the corresponding operation; if the fingerprint information collected by the fingerprint collection circuit does not match fingerprint information of an authorized user, the verification of the collected fingerprint information may be deemed unsuccessful, and the control assembly 1140 or the server may refuse the corresponding operation.

The electric vehicle 1100 may further include a control assembly 1140 mounted on the body 1110 and a vehicle control button electrically connected to the control assembly 1140. In some embodiments, the vehicle control button is a vehicle return button 1150. Preferably, the control assembly 1140 may be set on the rear frame 1113 of the body 1110.

The control assembly 1140 may include an operation panel 1141 facing a user, and the vehicle return button 1150 may be set on the operation panel 1141.

As shown in FIGS. 11-13, the control assembly 1140 may be located above the rear wheel assembly 1130. The control assembly 1140 may include a housing 1145 having a first surface 1146 obliquely upward and facing a rear of the vehicle, and a second surface 1147 that matches the rear wheel assembly 1130. The operation panel 1141 may be set on the first surface 1146. The first surface 1146 may be obliquely upward and may face the rear of the vehicle, which facilitates the user of the electric vehicle 1100 to observe the operation panel 1141, and facilitates the vehicle borrow or return. Actually, in other embodiments, the first surface 1146 could also be horizontally upward, or vertically backward, and at other gestures. Alternatively, the first surface 1146 may face the rear of the vehicle and have a first inclination angle θ1. For example, the first inclination angle θ1 may be greater than 0° and less than 90°. Alternatively, the first surface 1146 may face the two sides of the vehicle. Alternatively, the first surface 1146 may be horizontally downward. Furthermore, the second surface 1147 may be a curved surface. The rear wheel assembly 1130 may include a rear wheel mudguard 1132, and the curved surface of the second surface 1147 may be matched with the rear wheel mudguard 1132.

Furthermore, the housing 1145 may have a third surface 1148 facing a rear of the vehicle and a mounting surface 1149. The electric vehicle 1100 may further include a rear light reflecting device or a rear light-emitting device 1160 arranged on the third surface 1148. For example, the third surface 1148 may have a second inclination angle θ2. In some embodiments, the second inclination angle θ2 may be greater than 0° and less than 90°. For example, the second inclination angle θ2 may be equal to 0°, namely, the third surface is vertically backward. In some embodiments, the second inclination angle θ2 may be different from the first inclination angle θ1 of the first surface. For example, the first inclination angle θ1 may be greater than 0° and less than 90°, and the second inclination angle θ2 may be equal to 0°. That is, the first surface may be obliquely upward and face the rear of the vehicle, and the third surface may face the rear of the vehicle vertically. A mounting portion 1114 may be set on the rear frame 1113 of the body 1110. The mounting surface 1149 and the mounting portion 1114 may be connected to allow the control assembly 1140 to be fixed on the body 1110.

In some embodiments, a light-emitting device (not shown in the figure) facilitating the user to find or identify the vehicle return button 1150 may be set on the operation panel 1141. When the electric vehicle 1100 is in a predetermined status, the light-emitting device may emit a continuous light or blinks. For example, when it is determined that the vehicle is returned, the light-emitting device emits the continuous light or blinks to notify the user that the electric vehicle 1100 has been returned. For another example, when it is determined that the vehicle is borrowed, the light-emitting device emits the continuous light or blinks. For another example, when it is determined that the vehicle is temporarily locked, the light-emitting device emits the continuous light or blinks. Specifically, the light-emitting device could be either arranged around or at one side of the vehicle return button 1150, or arranged inside the vehicle return button 1150, so that the vehicle return button 1150 glows integrally. In some embodiments, when the electric vehicle 1100 is in the different predetermined statuses, the light-emitting device may have different light-emitting effects. For example, when it is determined that the vehicle is returned, the light-emitting device may emit a continuous light; and when it is determined that the vehicle is temporarily locked, the light-emitting device may blink.

In some embodiments, a sounding device (not shown in the figure) may be set on the operation panel 1141. When the electric vehicle 1100 is in the predetermined status, the sounding device may generate a sound. For example, when it is determined that the vehicle is returned, the sounding device may generate the sound to notify the user that the electric vehicle 1100 has been returned. For another example, when it is determined that the vehicle is borrowed, the sounding device may generate the sound. For another example, when it is determined that the vehicle is temporarily locked, the sounding device may generate the sound. In some embodiments, when the electric vehicle 1100 is in the different predetermined statuses, the sounding device may have different sounding effects. For example, when it is determined that the vehicle is returned, the sounding device may generate two sounds continuously; and when it is determined that the vehicle is temporarily locked, the sounding device may generate a sound.

Further, the operation panel 1141 may further include a quick response code 1142 for identifying the vehicle. Preferably, the quick response code 1142 may be located at the midpoint of the operation panel 1141, and the vehicle return button 1150 may be located below the quick response code 1142. Actually, the quick response code 1142 may also be arranged at other positions of the electric vehicle 1100. Specifically, the quick response code 1142 could be arranged on at least one of the first surface 1146, the second surface 1147 and the third surface 1148 of the housing 1145.

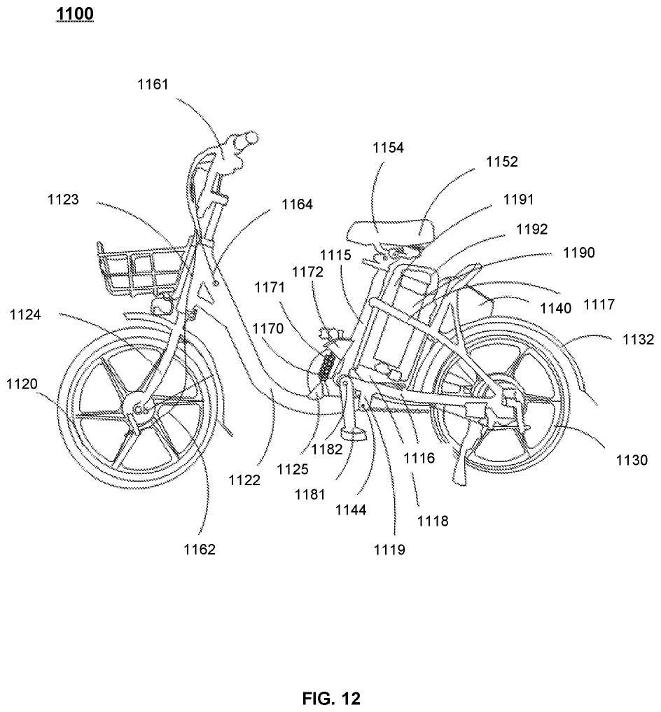

Referring back to FIG. 11 and FIG. 12, the electric vehicle 1100 may further include a damping device 1170.

Preferably, the damping device 1170 may include a damping spring 1171. Optionally, the damping device 1170 may further include a damping cylinder and other damping structures. In addition, as shown in FIG. 11 and FIG. 12, the damping device 1170 may further include a mask 1172 that matches the damping spring 1171.

As shown in FIG. 11 and FIG. 12, the front frame 1121 and the rear frame 1113 may be movably connected. The front frame 1121 may be equipped with a down tube 1122 extending to the bottom of the body 1110, and the rear frame 1113 may be equipped with a seat tube 1115. Specifically, the damping device 1170 may be arranged between the down tube 1122 and the seat tube 1115. With such setting, when the electric vehicle 1100 is ridden on an uneven and bumpy road, the range of sharp shake that the front wheel assembly 1120 and the rear wheel assembly 1130 transmit to the body 1110 may be correspondingly reduced through the damping device 1170. In addition, the mask 1172 is arranged on the seat tube 1115.

The down tube 1122 may include a first mounting portion 1125 protruded upward, and the seat tube 1115 may include a second mounting portion (not shown in the figure) arranged at the lower part of the seat tube 1115 and protruded towards the direction of a front of the vehicle. The damping device 1170 may be connected between the first mounting portion 1125 and the second mounting portion.

Further, the front frame 1121 may further include a front tube 1123 and a front fork 1124, wherein the front fork 1124 may be connected to the front wheel assembly 1120 for matching. An integral structure may be formed by the down tube 1122 and the front tube 1123. The down tube 1122 and the front tube 1123 could be either integrated or connected by welding and other processes.

Referring back to FIG. 12, a first connecting portion (not shown in the figure) may be arranged at the free end of the down tube 1122. The rear frame 1113 may include a rear fork 1116 connected to the seat tube 1115, wherein the rear fork 1116 may be connected to and match with the rear wheel assembly 1130. A second connecting portion 1119 may be arranged at the position that the rear fork 1116 is close to the seat tube 1115. The first connecting portion and the second connecting portion 1119 may be movably connected.

The body 1110 may further include a rotating shaft 1144, a first mounting hole (not shown in the figure) formed on the first connecting portion, and a second mounting hole (not shown in the figure) formed on the second connecting portion 1119. The rotating shaft 1144 may be matched with the first mounting hole and the second mounting hole respectively, to achieve a rotatable connection between the first connecting portion and the second connecting portion 1119.

The electric vehicle 1100 may further include a pedal assembly 1180. The pedal assembly 1180 may include a pedal 1181 and a connecting shaft 1182; and an axle hole (not shown in the figure) matched with the connecting shaft 1182 arranged at the joint of the seat tube 1115 and the rear fork 1116.

In some embodiments, after the pedal assembly 1180 is mounted on the electric vehicle 1100, the damping device 1170 may be located at the front side of the connecting shaft 1182 of the pedal assembly 1180, namely, the damping device 1170 may be located at one side that the connecting shaft 1182 of the pedal assembly 1180 is close to the front of the vehicle. The rotating shaft 1144 may be located at the rear side of the connecting shaft 1182 of the pedal assembly, namely, the rotating shaft 1144 may be located at one side that the connecting shaft 1182 of the pedal assembly 1180 may be close to the rear of the vehicle. In some embodiments, a triangle may be formed at the location of the first mounting portion 1125, the second mounting portion and the rotating shaft 1144. The position of the connecting shaft 1182 of the pedal assembly 1180 may be located in the triangle. With such setting, the overall reliability of the electric vehicle 1100 could be improved.

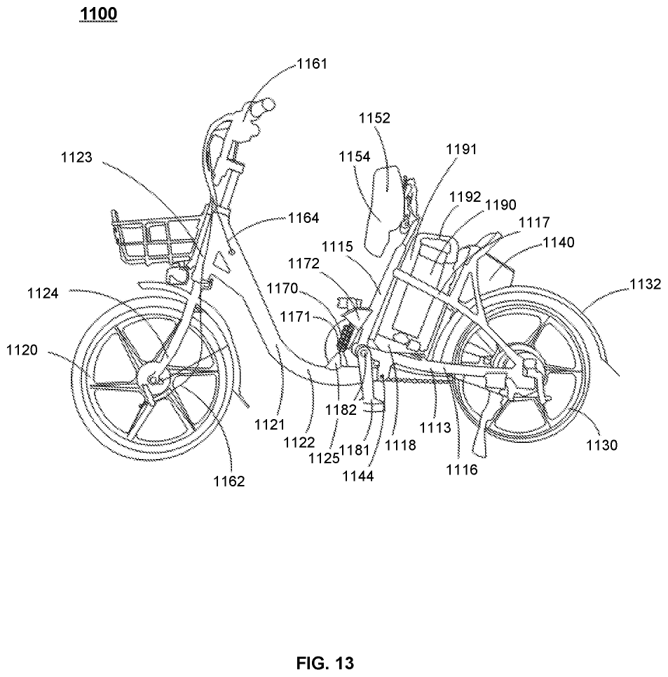

Referring to FIG. 11 and FIG. 12 and in combination with FIG. 13, the electric vehicle 1100 may further include a battery assembly 1190 providing a power for the front wheel assembly 1120 or the rear wheel assembly 1130. The battery assembly 1190 may be electrically connected to the control assembly 1140.

In some embodiments, the battery assembly 1190 may be arranged at the rear side of the seat tube 1115, namely, the battery assembly 1190 may be arranged at one side that the seat tube 1115 is close to the rear of the vehicle. In the embodiments, the mounting portion 1114 may be located between the battery assembly 1190 and the control assembly 1140.

The rear frame 1113 may further include a support rod 1117 connecting the rear fork 1116 and the seat tube 1115. The support rod 1117 may include two support rods arranged symmetrically and respectively located at the two sides of the battery assembly 1190, to prevent the battery assembly 1190 from loosening from the rear frame 1113. Optionally, the mounting portion 1114 for mounting the control assembly 1140 may be arranged on the support rod 1117.

Further, the battery assembly 1190 may include a battery shell 1191, a battery (not shown in the figure) arranged in the battery shell 1191 and a first interface (not shown in the figure) located on the battery shell 1191 and electrically connected to the battery. The electric vehicle 1100 may include a base 1118 arranged on the rear frame 1113, and a second interface (not shown in the figure) matched with the first interface is arranged on the base 1118. Optionally, the first interface may be located on the bottom surface of the battery shell 1190, and the second interface may be arranged on the upper surface of the base 1118.

Further, the battery shell 1191 may also be equipped with a lifting portion 1192 arranged on the top of the battery shell. The battery shell 1191 may be equipped with a chute (not shown in the figure), and the rear frame 1113 may be equipped with a guide bulge (not shown in the figure) matched with the chute. Optionally, a chute may be arranged on the rear frame 1113, and a guide bulge (not shown in the figure) matched with the chute is arranged on the battery shell 1191. With such setting, an operator could conveniently operate the lifting portion 1192 to take out the battery assembly 1190 from the rear frame 1113 or mount the battery assembly.

The body 1110 may further include a saddle assembly 1152 arranged on the rear frame 1113. The saddle assembly 1152 may include a saddle 1154 matched with the seat tube 1115. The battery assembly 1190 may be mounted behind the rear frame 1113, and the saddle 1154 may be located above the battery assembly 1190.

Referring to FIG. 13, preferably, the saddle 1154 may be a reversible saddle. The saddle may be reversed forward for a predetermined angle towards the front of the vehicle, so that the saddle 1154 may be located outside a moving path of the battery assembly 1190 when the lifting portion 1192 of the battery assembly 1190 could be taken out upward or mounted downward by the operator.

In some embodiments, the vehicle control button 1150 could be arranged on the saddle assembly 1152. Specifically, the vehicle control button 1150 could be arranged on the rear of the saddle 1154. Alternatively, the vehicle control button 1150 could be arranged below the saddle 1154. Alternatively, the vehicle control button 1150 could be arranged at a position that the seat tube 1115 is close to the saddle 1154.

In addition, an electronic lock (not shown in the figure) matched with the rear frame 1113 for preventing the battery assembly 1190 from being stolen may also be arranged on the battery assembly 1190.

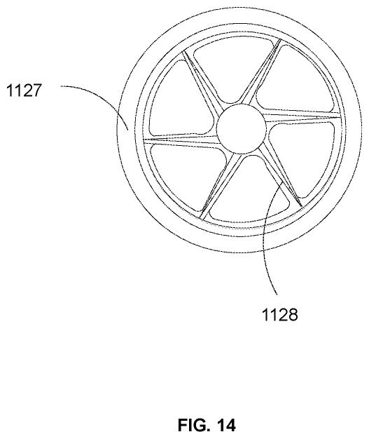

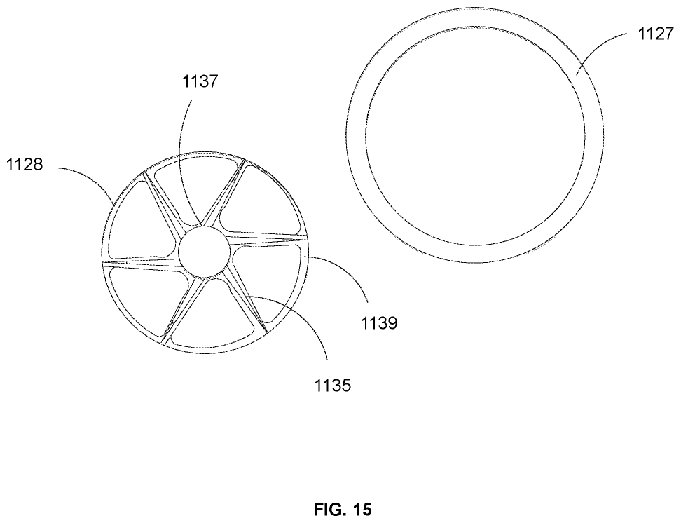

With reference to FIG. 11 to FIG. 13, and in combination with FIG. 14 and FIG. 15, the front wheel assembly 1120 may include a front tyre 1127, a front wheel 1128 and a front headset 1126, wherein the front wheel 1128 may include a front wheel spoke 1135, a front mounting end 1137 matched with the front headset 1126 and a front rim 1139 matched with the front tyre 1127.

In some embodiments, the front wheel spoke 1135, the front mounting end 1137 and the front rim 1139 may be in an integrated structure. Further, the front wheel 1128 may be a forged aluminum alloy wheel.

it should be noted that, since the front wheel assembly 1120 roughly has the same structure with the rear wheel assembly 1130, FIG. 14 and FIG. 15 could be regarded as a schematic diagram for a partial structure of the rear wheel assembly 1130.

The rear wheel assembly 1130 may further include a rear tyre 1134, a rear wheel 1136 and a rear headset 1138, wherein the rear wheel 1136 may include a rear wheel spoke, a rear mounting end matched with the rear headset 1138 and a rear rim matched with the rear tyre 1134.

In some embodiments, the rear wheel spoke, the rear mounting end and the rear rim may be in the integrated structure. Further, the rear wheel 1136 may be a forged aluminum alloy wheel.

Further, the front tyre 1127 or the rear tyre 1134 may be one of a solid tyre or a hollow non-pneumatic tyre.

In addition, with continuous reference to FIG. 11 to FIG. 13, the body 1110 may further include a handlebar assembly 1161 arranged on the front frame 1121, wherein the handlebar assembly 1161 may be matched with the front tube 1123 of the front frame 1121.

Further, the handlebar assembly 1161 may be equipped with a first cable 1162 connected to the front headset 1126, and the front tube 1123 or the front fork 1124 may be equipped with a first positioning portion (not labeled) for positioning the first cable 1162.

Further, a channel (not shown in the figure) may be arranged in the down tube 1122. The handlebar assembly 1161 may be equipped with a second cable 1164 connected to the rear headset 1138. The second cable 1164 may be connected to the rear headset 1138 through the channel. Further, a second positioning portion (not labeled) for positioning the second cable 1164 may be arranged on the rear fork 1116 of the rear frame 1113.

In some embodiments, the vehicle control button 1150 could be arranged on the handlebar assembly 1161. Specifically, the handlebar assembly may further include a handle 1166 and a handlebar assembly center shaft 1168. The vehicle control button 1150 could be arranged on the handle 1166. Alternatively, the vehicle control button 1150 could be arranged on the handlebar assembly center shaft 1168.

In some embodiments, the electric vehicle 1100 may further include one or more pressure sensors (not shown in the figure) connected to the control assembly 1140 by signals. Preferably, the one or more sensors could be arranged on the saddle assembly 1152. The control assembly 1140 may control the vehicle to be a predetermined status when the vehicle control button 1150 is pressed and/or a pressure detected by the one or more pressure sensors satisfies a predetermined condition. For example, in a vehicle borrowing scenario, the user may firstly press the vehicle control button 1150, and the control assembly 1140 may control the vehicle motor to be in a standby state. Then, the user may sit on the saddle 1154, and the pressure detected by the one or more pressure sensors may reach a predetermined threshold, the control assembly 1140 may control the vehicle motor to rotate, and the user could ride the vehicle. For another example, in a vehicle return scenario, the user may firstly get off the saddle 1154, the pressure detected by the one or more pressure sensors may be less than the predetermined threshold, and the control assembly 1140 may control the vehicle motor to be in the standby state. Then, the user may press the vehicle control button 1150, the control assembly 1140 may control the vehicle motor to close, and the user may finish riding, and thus, finish the vehicle return. For another example, in a vehicle return scenario, the user may firstly get off the saddle 1154 and park the vehicle, and when the pressure detected by the one or more sensors is less than a predetermined pressure threshold and the duration reaches the predetermined time threshold, the control assembly 1140 may control the vehicle motor to shut down, the user may finish riding, and the vehicle return may be automatically completed without manual operation by the user.

Through the embodiments as stated above, for the electric vehicle 1100 of the present disclosure, the vehicle wheel (the front wheel 1128 or the rear wheel 1136) may be arranged into an integrated structure, and further, the vehicle wheel may be arranged into a forged aluminum alloy hub, thereby increasing the vehicle reliability. Meanwhile, the tyre (the front tyre 1127 or the rear tyre 1134) may be designed into the solid tyre or the hollow non-pneumatic tyre, thereby cancelling the tire tube of the vehicle, and improving the reliability of the vehicle tyre. Therefore, with such setting of the present disclosure, the user experience could be improved, the product reliability is improved, and the overall product competitiveness is enhanced.

Having thus described the basic concepts, it may be rather apparent to those skilled in the art after reading this detailed disclosure that the foregoing detailed disclosure is intended to be presented by way of example only and is not limiting. Various alterations, improvements, and modifications may occur and are intended to those skilled in the art, though not expressly stated herein. These alterations, improvements, and modifications are intended to be suggested by this disclosure and are within the spirit and scope of the exemplary embodiments of this disclosure.

Moreover, certain terminology has been used to describe embodiments of the present disclosure. For example, the terms “one embodiment,” “an embodiment,” and/or “some embodiments” mean that a particular feature, structure or characteristic described in connection with the embodiment is included in at least one embodiment of the present disclosure. Therefore, it is emphasized and should be appreciated that two or more references to “an embodiment” or “one embodiment” or “an alternative embodiment” in various portions of this specification are not necessarily all referring to the same embodiment. Furthermore, the particular features, structures or characteristics may be combined as suitable in one or more embodiments of the present disclosure.

Further, it will be appreciated by one skilled in the art, aspects of the present disclosure may be illustrated and described herein in any of a number of patentable classes or context including any new and useful process, machine, manufacture, or composition of matter, or any new and useful improvement thereof. Accordingly, aspects of the present disclosure may be implemented entirely hardware, entirely software (including firmware, resident software, micro-code, etc.) or combining software and hardware implementation that may all generally be referred to herein as a “unit,” “module,” or “system.” Furthermore, aspects of the present disclosure may take the form of a computer program product embodied in one or more computer-readable media having computer readable program code embodied thereon.

A non-transitory computer readable signal medium may include a propagated data signal with computer readable program code embodied therein, for example, in baseband or as part of a carrier wave. Such a propagated signal may take any of a variety of forms, including electromagnetic, optical, or the like, or any suitable combination thereof. A computer readable signal medium may be any computer readable medium that is not a computer readable storage medium and that may communicate, propagate, or transport a program for use by or in connection with an instruction execution system, apparatus, or device. Program code embodied on a computer readable signal medium may be transmitted using any appropriate medium, including wireless, wireline, optical fiber cable, RF, or the like, or any suitable combination of the foregoing.

Computer program code for carrying out operations for aspects of the present disclosure may be written in any combination of one or more programming languages, including an object-oriented programming language such as Java, Scala, Smalltalk, Eiffel, JADE, Emerald, C++, C#, VB. NET, Python or the like, conventional procedural programming languages, such as the “C” programming language, Visual Basic, Fortran 2003, Perl, COBOL 2002, PHP, ABAP, dynamic programming languages such as Python, Ruby, and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider) or in a cloud computing environment or offered as a service such as a Software as a Service (SaaS).

Furthermore, the recited order of processing elements or sequences, or the use of numbers, letters, or other designations, therefore, is not intended to limit the claimed processes and methods to any order except as may be specified in the claims. Although the above disclosure discusses through various examples what is currently considered to be a variety of useful embodiments of the disclosure, it is to be understood that such detail is solely for that purpose and that the appended claims are not limited to the disclosed embodiments, but, on the contrary, are intended to cover modifications and equivalent arrangements that are within the spirit and scope of the disclosed embodiments. For example, although the implementation of various components described above may be embodied in a hardware device, it may also be implemented as a software-only solution, e.g., an installation on an existing server or mobile device.

Similarly, it should be appreciated that in the foregoing description of embodiments of the present disclosure, various features are sometimes grouped together in a single embodiment, figure, or description thereof to streamline the disclosure aiding in the understanding of one or more of the various inventive embodiments. This method of disclosure, however, is not to be interpreted as reflecting an intention that the claimed object matter requires more features than are expressly recited in each claim. Rather, inventive embodiments lie in less than all features of a single foregoing disclosed embodiment.

In some embodiments, the numbers expressing quantities, properties, and so forth, used to describe and claim certain embodiments of the application are to be understood as being modified in some instances by the term “about,” “approximate,” or “substantially.” For example, “about,” “approximate,” or “substantially” may indicate ±20% variation of the value it describes, unless otherwise stated. Accordingly, in some embodiments, the numerical parameters set forth in the written description and attached claims are approximations that may vary depending upon the desired properties sought to be obtained by a particular embodiment. In some embodiments, the numerical parameters should be construed in light of the number of reported significant digits and by applying ordinary rounding techniques. Notwithstanding that the numerical ranges and parameters setting forth the broad scope of some embodiments of the application are approximations, the numerical values set forth in the specific examples are reported as precisely as practicable.

Each of the patents, patent applications, publications of patent applications, and other material, such as articles, books, specifications, publications, documents, things, and/or the like, referenced herein is hereby incorporated herein by this reference in its entirety for all purposes, excepting any prosecution file history associated with same, any of same that is inconsistent with or in conflict with the present document, or any of same that may have a limiting affect as to the broadest scope of the claims now or later associated with the present document. By way of example, should there be any inconsistency or conflict between the description, definition, and/or the use of a term associated with any of the incorporated material and that associated with the present document, the description, definition, and/or the use of the term in the present document shall prevail.

In closing, it is to be understood that the embodiments of the application disclosed herein are illustrative of the principles of the embodiments of the application. Other modifications that may be employed may be within the scope of the application. Thus, by way of example, but not of limitation, alternative configurations of the embodiments of the application may be utilized in accordance with the teachings herein. Accordingly, embodiments of the present application are not limited to that precisely as shown and described.

1. A control device in communication with a server via a network, comprising:
a return component mounted on an item, configured to:
receive an operation of a user on the return component; and
generate a return request based on the operation of the user on the return component; and
a transceiver mounted on the item, configured to:
establish a connection with the server;
encrypt the return request and identification information of the item to generate encrypted data; and
transmit the encrypted data to the server to register a return of the item on the server.

2. The control device of claim 1, wherein the transceiver is further configured to:
receive a return completion signal from the server; and
cause a lock mounted on the item to lock the item according to the return completion signal.

3. The control device of claim 1, wherein the return component includes at least one of: a button, a knob, a microphone, a switch, or a touch screen.

4. The control device of claim 1, wherein the operation on the return component includes at least one of: a touch, a gesture, a voice command, a press, a pull, a drag, a rotation, a movement, or a click.

5. A server in communication with a control device on an item and a user device via a network, configured to:
receive, from the control device, first encrypted data including a return request of the item and identification information of the item;
decrypt the first encrypted data to generate the return request of the item and the identification information of the item;
determine an account associated with the identification information of the item;
determine whether the item is checked out to the account to obtain a determination result;
generate, based on the determination result, second data including information regarding the account;
encrypt the second data; and
push the second encrypted data to the user device associated with the account.

6. The server of claim 5, wherein to determine whether the item is checked out to the account to obtain a determination result includes determining that the item is not checked out to the account, and wherein the second data include a verification request associated with the account.

7. The server of claim 5, wherein to determine whether the item is checked out to the account to obtain a determination result includes determining that the item is checked out to the account, and wherein the second data include a status change of the account relating to the item from checkout to return.

8. The server of claim 7, the server is further directed to:
charge a fee on the account.

9. The server of claim 7, wherein the second data further include a return completion signal associated with the account.

10. The server of claim 5, wherein to determine an account associated with the identification information, the server is directed to:
obtain a lookup table recording mappings between identification information of a plurality of items and a plurality of accounts, wherein the lookup table is updated each time when one of the plurality of items is checked out or returned; and
search the lookup table based on the identification information of the item to identify the account to which the item is checked out.

11. The server of claim 10, wherein to determine whether the item is checked out to the account to obtain a determination result, the server is further directed to:
determine that the item is checked out to the account; and
delete, from the lookup table, the mapping between the identification information of the item and the account to which the item is checked out.

12-30. (canceled)

31. A vehicle control device, comprising:
a control assembly and a vehicle control button, the vehicle control button being electrically connected to the control assembly.

32. The vehicle control device of claim 31, wherein the control assembly includes an operation panel, and the vehicle control button is set on the operation panel.

33. The vehicle control device of claim 32, wherein the control assembly includes a cover having a first surface, and the operation panel is set on the first surface.

34. (canceled)

35. (canceled)

36. The vehicle control device of claim 33, wherein the cover includes a second surface that matches a shape of a rear wheel assembly of the vehicle.

37. The vehicle control device of claim 36, wherein
the cover includes a third surface facing a rear of the vehicle, and
a rear light reflector or a rear light emitter is set on the third surface.

38. (canceled)

39. The vehicle control device of claim 32, wherein the operation panel includes a quick response code for identifying the vehicle.

40. (canceled)

41. (canceled)

42. The vehicle control device of claim 32, wherein a light emitter is set on the operation panel.

43-46. (canceled)

47. The vehicle control device of claim 31, wherein the control assembly generates a signal of a vehicle status changing request when the vehicle control button is pressed and transmits the signal of the vehicle status changing request to a server so that the vehicle is set to a predetermined status.

48. (canceled)

49. The vehicle control device of claim 31, wherein a fingerprint collection circuit is set on the vehicle control button, and the fingerprint collection circuit and the vehicle control button are operably connected to exchange signals.

50-69. (canceled)
